(19) United States
(12) Patent Application Publication
(10) Pub. No.: US 2026/0358560 A1
(43) Pub. Date: Nov. 12, 2026

(54) OPTICAL FIBER HOLDER

(71) Applicant: SUMITOMO ELECTRIC OPTIFRONTIER CO., LTD., Kanagawa (JP)

(72) Inventors: Shinsuke KURINO, Kanagawa (JP); Yoshinobu TODA, Kanagawa (JP); Kazufumi JOKO, Kanagawa (JP)

(21) Appl. No.: 19/129,129

(22) PCT Filed: Nov. 13, 2023
(86) PCT No.: PCT/JP2023/040768

§ 371 Date: May 12, 2025

(30) Foreign Application Priority Data
Nov. 16, 2022 (JP) 2022-183494

(51) Int. Cl. G02B 6/255; G02B 6/25

(52) U.S. Cl. CPC G02B 6/2553; G02B 6/25; G02B 6/2556

(57) ABSTRACT

An optical fiber holder according to one embodiment includes a base member; and a guide member placed on the base member. The guide member has a first surface and a second surface facing a side opposite the first surface. The guide member is placeable on the base member with either the first surface or the second surface facing upward. The first surface includes a first insertion portion in which a first insertion space into which an optical fiber is inserted is formed, and the second surface includes a second insertion portion in which a second insertion space into which an optical fiber is inserted is formed. A width of the first insertion space is different from a width of the second insertion space.

### TECHNICAL FIELD

The present disclosure relates to an optical fiber holder.

Priority is claimed on Japanese Patent Application No. 2022-183494, filed on Nov. 16, 2022, the entire content of which is incorporated herein by reference.

### BACKGROUND ART

Patent Literature 1 describes a holder to which an optical fiber holder that holds an optical fiber can be attached. The holder is a jig that can be set in an optical fiber processing device in a state where the optical fiber holder that holds the optical fiber is attached. The positions of the optical fiber holder and the optical fiber with respect to the optical fiber processing device are aligned by attaching the optical fiber holder to the holder.

A first optical fiber holder, a second optical fiber holder, and a third optical fiber holder having different shapes can be attached to the holder. The first optical fiber holder grips and fixes a rectangular optical cable. The second optical fiber holder is a grip member that grips an outer sheath of a rectangular optical cable. The third optical fiber holder includes a jig body having a rod shape and a fiber pressing portion provided on the front side of the jig body.

Patent Literature 2 describes a handling optical fiber holder. The handling optical fiber holder includes a substrate on which has an accommodation groove that accommodates a single-core optical fiber, and a lid that is openably and closably connected to the substrate. In the substrate, a pressure-receiving elastic body is disposed in the accommodation groove, and a positioning groove for positioning the optical fiber is formed at a position adjacent to the accommodation groove. The lid includes a support plate including a pressing elastic body that grips the optical fiber between the pressing elastic body and the pressure-receiving elastic body using a frictional force when the lid is closed, and a spring that biases the support plate toward the substrate.

### CITATION LIST

### Patent Literature

Patent Literature 1: PCT International Publication No. WO 2017/126628

Patent Literature 2: Japanese Utility Model Registration No. 3132149

### SUMMARY OF INVENTION

An optical fiber holder according to the present disclosure includes a base member; and a guide member placed on the base member. The guide member has a first surface and a second surface facing a side opposite the first surface. The guide member is placeable on the base member with either the first surface or the second surface facing upward. The first surface includes a first insertion portion in which a first insertion space into which an optical fiber is inserted is formed. The second surface includes a second insertion portion in which a second insertion space into which an optical fiber is inserted is formed. A width of the first insertion space is different from a width of the second insertion space.

### BRIEF DESCRIPTION OF DRAWINGS

FIG. 1 is a perspective view showing an optical fiber cutter that is one example of an attachment object to which an optical fiber holder according to an embodiment is attached.

FIG. 2 is a perspective view showing the optical fiber holder according to the embodiment.

FIG. 3 is a perspective view showing the optical fiber cutter of FIG. 1.

FIG. 4 is a perspective view showing the optical fiber holder of FIG. 2.

FIG. 5 is a view showing a first surface of a guide member of the optical fiber holder of FIG. 2.

FIG. 6 is a view showing a second surface of the guide member of the optical fiber holder of FIG. 2.

FIG. 7 is a view showing a side surface of the guide member of the optical fiber holder of FIG. 2.

FIG. 8 is a perspective view showing a procedure for mounting the guide member on a base member of the optical fiber holder of FIG. 2.

FIG. 9 is a perspective view showing the base member and the guide member of FIG. 8.

FIG. 10 is a plan view showing the base member and the guide member of FIG. 8.

FIG. 11 is a perspective view showing holes formed in the optical fiber cutter of FIG. 1 and the base member.

FIG. 12 is a perspective view showing a part of the optical fiber cutter and the base member of FIG. 1.

### DESCRIPTION OF EMBODIMENTS

The optical fiber holder may be required to be able to hold a plurality of types of optical fibers. The holder described above can hold a plurality of types of optical fiber holders, and the plurality of types of optical fiber holders can hold different types of optical fibers. However, since the plurality of optical fiber holders should be manufactured in advance, a problem of an increased number of components may occur. Therefore, it is required to suppress an increase in the number of components while holding the plurality of types of optical fibers.

An object of the present disclosure is to provide an optical fiber holder capable of suppressing an increase in the number of components while holding a plurality of types of optical fibers.

### [Description of Embodiment of Present Invention]

First, embodiments of the present invention will be listed. (1) An optical fiber holder according to an embodiment includes a base member; and a guide member placed on the base member. The guide member has a first surface and a second surface facing a side opposite the first surface. The guide member is placeable on the base member with either the first surface or the second surface facing upward. The first surface includes a first insertion portion in which a first insertion space into which an optical fiber is inserted is formed. The second surface includes a second insertion portion in which a second insertion space into which an optical fiber is inserted is formed. A width of the first insertion space is different from a width of the second insertion space.

The optical fiber holder includes the guide member placed on the base member, and the guide member has the first surface and the second surface facing the side opposite the first surface. The first surface includes the first insertion portion in which the first insertion space into which an optical fiber is inserted is formed, and the second surface includes the second insertion portion in which the second insertion space into which an optical fiber is inserted is formed. The width of the first insertion space is different from the width of the second insertion space. Therefore, the type of the optical fiber inserted into the first insertion space and the type of the optical fiber inserted into the second insertion space can be made different from each other. Therefore, a plurality of types of optical fibers can be inserted. The guide member is placeable on the base member with either the first surface or the second surface facing upward. Therefore, by placing the guide member on the base member in a state where either the first surface or the second surface faces upward, a single guide member is allowed to hold a plurality of types of optical fibers. Therefore, an increase in the number of components can be suppressed while holding a plurality of types of optical fibers.

(2) In the above (1), the guide member may have a first end surface facing a first direction in which the optical fiber extends, and a second end surface facing a side opposite the first end surface. The first insertion portion may be formed between the first end surface and a reference line passing through a center of the guide member and extending along a second direction that is a width direction of the guide member. The second insertion portion may be formed between the reference line and the second end surface. In this case, the position of the first insertion portion in the first direction and the position of the second insertion portion in the first direction can be made different from each other. Therefore, an excessive increase in the thickness of the guide member can be suppressed.

(3) In the above (2), the first insertion portion may include a pair of first wall portions and a first bottom surface that define the first insertion space, and the second insertion portion may include a pair of second wall portions and a second bottom surface that define the second insertion space. The first bottom surface may be inclined such that the guide member becomes thinner as the first bottom surface extends toward the first end surface, and the second bottom surface may be inclined such that the guide member becomes thinner as the second bottom surface extends toward the second end surface. In this case, the alignment of the optical fiber can be easily performed.

(4) In the above (3), the base member may include recesses that either the pair of first wall portions or the pair of second wall portions enters. In this case, when the guide member is placed on the base member, either the pair of first wall portions or the pair of second wall portions enter the recesses of the base member. Therefore, the thickness of the optical fiber holder can be reduced.

(5) In any one of the above (1) to (4), the guide member may include a V-groove into which the optical fiber is inserted, and a pair of protruding portions located on both sides of the V-groove.

(6) In the above (3) or (4), the guide member may include a V-groove into which the optical fiber is inserted, and the first bottom surface may be formed on an extension line of the V-groove extending linearly.

(7) In the above (6), the first bottom surface may have an inclined surface extending obliquely downward from an end portion of the V-groove, and an extending surface extending from an end portion of the inclined surface opposite the V-groove.

(8) In any one of the above (1) to (7), the optical fiber holder may include an attachment portion to which the base member is attached, and the attachment portion includes a pair of openings. The base member may include a base portion on which the guide member is placed, and protruding portions protruding from the base portion in a width direction of the base member, and the protruding portions may be inserted into the openings.

(9) In any one of the above (1) to (8), the guide member may include a plate-shaped portion attached to the base member, and may be placeable on the base member in a state where an orientation of the plate-shaped portion in a thickness direction is changed.

(10) In any one of the above (1) to (9), a mark indicating the first surface may be formed on the first surface, and a mark indicating the second surface may be formed on the second surface.

(11) In any one of the above (1) to (10), a type of the optical fiber placed on the first surface and a type of the optical fiber placed on the second surface may be different from each other.

(12) In any one of the above (1) to (11), the optical fiber holder may be attached to an attachment object. The base member may include a projection that enters a depression formed in the attachment object. A position of the projection with respect to the base member may be changeable by elastic deformation. In this case, the base member includes the projection that enters the depression in the attachment object, and the position of the projection with respect to the base member is changeable by elastic deformation. Therefore, the optical fiber holder can be easily attached to the attachment object by bending the projection.

(13) In the above (12), the base member may include a base portion on which the guide member is placed, and a slit penetrating through the base portion and formed in a U-shape in a bottom view, and the projection may be formed inside the slit in a bottom view.

(14) In any one of the above (1) to (13), the optical fiber holder may be attached to an attachment object. The base member may include a pawl portion that is inserted into a hole formed in the attachment object. A lifting of the base member from the attachment object may be suppressed in a state where the pawl portion is inserted into the hole. In this case, the base member includes the pawl portion that is inserted into the hole in the attachment object, and the lifting of the base member can be suppressed by inserting the pawl portion into the hole.

### [Details of Embodiment of Present Disclosure]

A specific example of an optical fiber holder according to an embodiment will be described below with reference to the drawings. Incidentally, the present invention is not limited to the following example, and is intended to include all modifications within the claims and equivalents to the claims. In the description of the drawings, the same or corresponding elements are denoted by the same reference signs, and duplicate descriptions will be omitted as appropriate. The drawings may be depicted partially in a simplified or exaggerated manner for ease of understanding, and dimensional ratios and the like are not limited to those shown in the drawings.

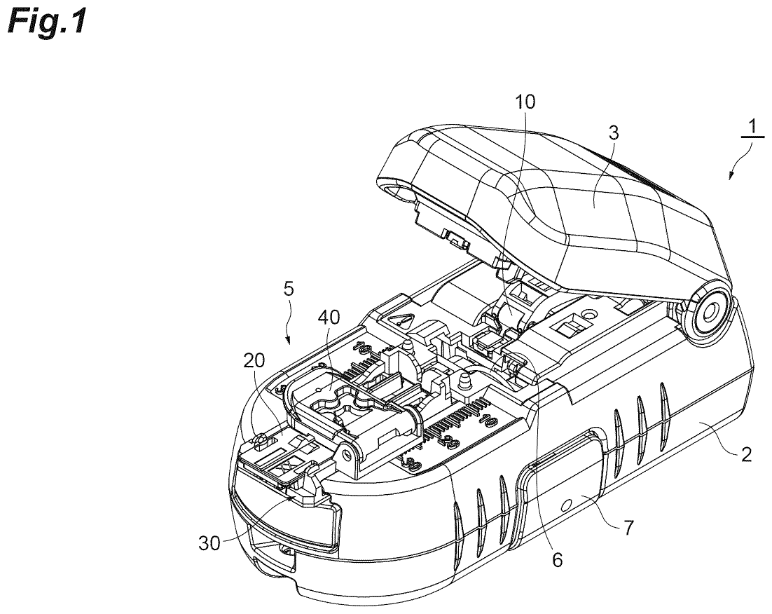

FIG. 1 is a perspective view showing an optical fiber cutter 1 that is an example of an attachment object to which an optical fiber holder 5 according to the present embodiment is attached. The optical fiber cutter 1 is, for example, a device that removes a glass fiber exposed by removing a coating from a tip portion of an optical fiber. For example, the optical fiber cutter 1 includes a base body 2, a cover 3, a blade 6 for cutting an optical fiber, a movable member 7, and a fiber holding portion 10. The cover 3 is openable and closeable with respect to the base body 2. The optical fiber cutter 1 cuts an optical fiber covered by the cover 3. For example, the cover 3 is rotatably connected to an end portion of the base body 2 via a shaft portion extending along a width direction of the base body 2.

The optical fiber holder 5 includes a guide member 20 and a base member 30. The optical fiber holder 5 holds the optical fiber that is cut by the blade 6. The base member 30 includes a cover 40 that covers the optical fiber guided by the guide member 20. The blade 6 is provided to score the optical fiber. For example, the blade 6 has a disk shape. The movable member 7 is provided on a side surface of the base body 2 that faces the width direction of the base body 2. The movable member 7 is movable in the width direction of the base body 2. The blade 6 rotates as the movable member 7 moves. The fiber holding portion 10 holds a tip portion of the optical fiber guided by the guide member 20. The optical fiber held by the fiber holding portion 10 is cut by the blade 6 that rotates as the movable member 7 moves.

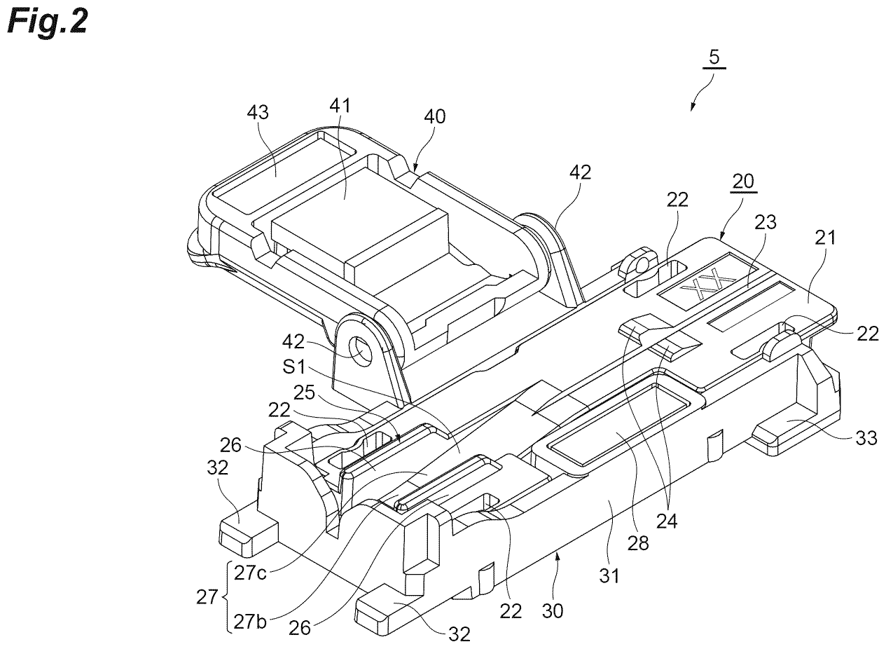

FIG. 2 is a perspective view showing the optical fiber holder 5. As shown in FIG. 2, the guide member 20 is placed on the base member 30. The guide member 20 includes, for example, a plate-shaped portion 21 attached to the base member 30. The guide member 20 has through-holes 22 penetrating the plate-shaped portion 21. The plate-shaped portion 21 has, for example, a rectangular shape with rounded corners. For example, the through-hole 22 is formed at each of the four corners of the plate-shaped portion 21.

The through-holes 22 extend along a longitudinal direction of the plate-shaped portion 21 (a direction in which long sides extend, namely, a direction extending from the lower left to the upper right in FIG. 2). The guide member 20 includes, for example, a V-groove 23 into which the optical fiber (optical fiber cable) is inserted, and a pair of protruding portions 24 located on both sides of the V-groove 23. The pair of protruding portions 24 are formed at an intermediate portion of the V-groove 23, which extends linearly, in the plate-shaped portion 21. For example, the pair of protruding portions 24 are formed at a midpoint of the V-groove 23 extending linearly. The pair of protruding portions 24 are aligned along a traverse direction of the plate-shaped portion 21 (a direction in which short sides extend, namely, a direction extending from the upper left to the lower right in FIG. 2) with the V-groove 23 sandwiched therebetween.

The guide member 20 includes a first insertion portion 25 in which a first insertion space S1 into which the optical fiber is inserted is formed. The first insertion portion 25 includes a pair of first wall portions 26 and a first bottom surface 27 that define the first insertion space S1. The first wall portions 26 are formed on both respective sides of the plate-shaped portion 21 in the width direction when viewed from the first bottom surface 27. The first wall portions 26 are portions protruding upward from the plate-shaped portion 21. The first bottom surface 27 is formed on an extension line of the V-groove 23 extending linearly. The first bottom surface 27 has an inclined surface 27c extending obliquely downward from an end portion of the V-groove 23, and an extending surface 27b extending from an end portion of the inclined surface 27c opposite the V-groove 23 to a longitudinal end of the plate-shaped portion 21.

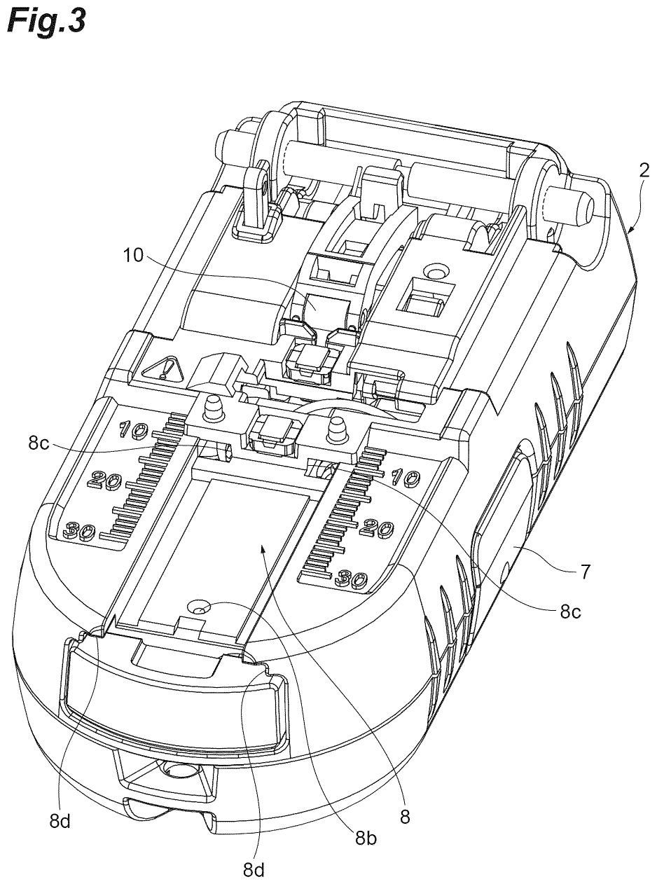

The base member 30 is attached to the optical fiber cutter 1 in a state where the base member 30 holds the guide member 20. FIG. 3 is a perspective view of the optical fiber cutter 1 with the cover 3 omitted. As shown in FIGS. 2 and 3, the optical fiber cutter 1 includes an attachment portion 8 to which the base member 30 is attached. The attachment portion 8 extends, for example, in a longitudinal direction of the base body 2 at the center of the base body 2 in the width direction. The attachment portion 8 includes a depression 8b depressed downward; a pair of holes 8c aligned along the width direction of the base body 2 in the vicinity of the longitudinal center of the base body 2; and a pair of openings 8d aligned along the width direction at a longitudinal end portion of the base body 2. For example, the holes 8c are open in a horizontal direction in a state where when the base body 2 is placed.

The base member 30 includes a base portion 31 on which the guide member 20 is placed; pawl portions 32 protruding from the base portion 31 in a longitudinal direction of the base member 30; and protruding portions 33 protruding from the base portion 31 in a width direction of the base member 30. The base portion 31 has a rectangular shape in a plan view. The pawl portions 32 have, for example, a plate shape. The pawl portions 32 further protrude from a longitudinal end portion of the base portion 31 in the longitudinal direction. The base member 30 includes a pair of the pawl portions 32, and the pair of pawl portions 32 are aligned in the width direction of the base portion 31.

The protruding portions 33 protrude from the base portion 31 in the width direction of the base portion 31 at an end portion of the base portion 31 opposite the pawl portions 32. The protruding portions 33 have, for example, a plate shape. The base member 30 includes a pair of the protruding portions 33, and the pair of protruding portions 33 are aligned in the width direction of the base portion 31. The pawl portions 32 of the base member 30 are inserted into the holes 8c of the attachment portion 8, and the protruding portions 33 of the base member 30 are inserted into the openings 8d of the attachment portion 8. Accordingly, the base member 30 is attached to the attachment portion 8, and the lifting of the base member 30 from the attachment portion 8 is suppressed.

The cover 40 includes, for example, a cover body 41 that covers the optical fiber inserted into the guide member 20; a shaft portion 42 extending along the longitudinal direction of the base portion 31 at a position adjacent to a long side of the base portion 31; and a magnet 43 fixed to the cover body 41. The cover body 41 is rotatable about the shaft portion 42. The base member 30 includes a magnet 28 provided at a position adjacent to a long side of the base portion 31. The magnet 28 is disposed on a side opposite the shaft portion 42 when viewed from the V-groove 23 of the guide member 20 placed on the base member 30. When the cover body 41 is rotated about the shaft portion 42, the magnet 43 is attracted to the magnet 28. Accordingly, a state where the cover 40 covers the guide member 20 is maintained.

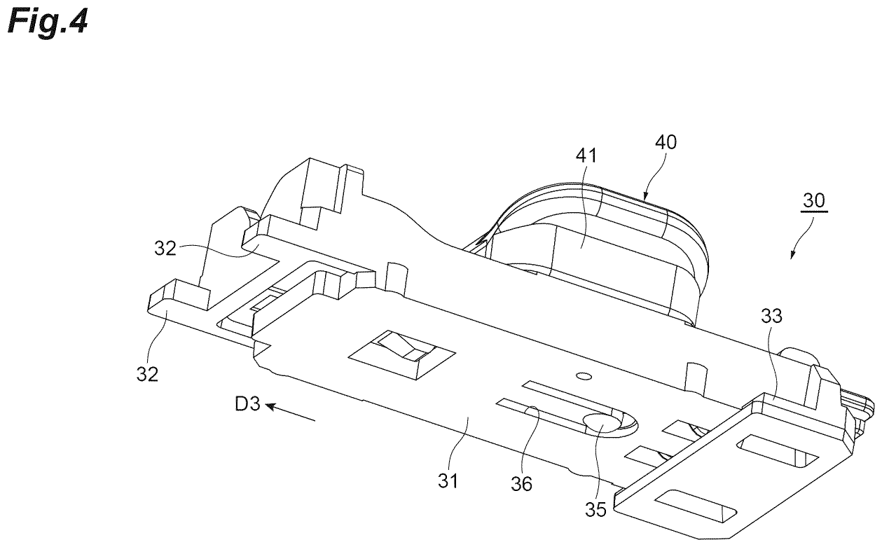

FIG. 4 is a perspective view of the base member 30 when the base member 30 is viewed in a direction different from that of FIG. 2. As shown in FIGS. 3 and 4, when a direction in which the pawl portions 32 protrude from the base portion 31 is defined as a third direction D3, the pawl portions 32 are inserted into the holes 8c along the third direction D3, and the protruding portions 33 are inserted into the openings 8d along the third direction D3. The base member 30 includes a projection 35 that enters the depression 8b.

The projection 35 is a portion protruding downward from a bottom surface of the base portion 31. The projection 35 has, for example, a hemispherical shape. The position of the projection 35 with respect to the base member 30 is changeable by elastic deformation along a thickness direction of the base member 30. For example, the base member 30 includes a slit 36 penetrating the base portion 31 in the thickness direction and formed in a U-shape in a bottom view. The projection 35 is formed inside the slit 36 in a bottom view. Namely, the projection 35 is formed between two vertical rod portions forming the U-shape of the slit 36. Accordingly, the position of the projection 35 with respect to the base member 30 is changeable by elastic deformation. The projection 35 itself may be elastically deformable.

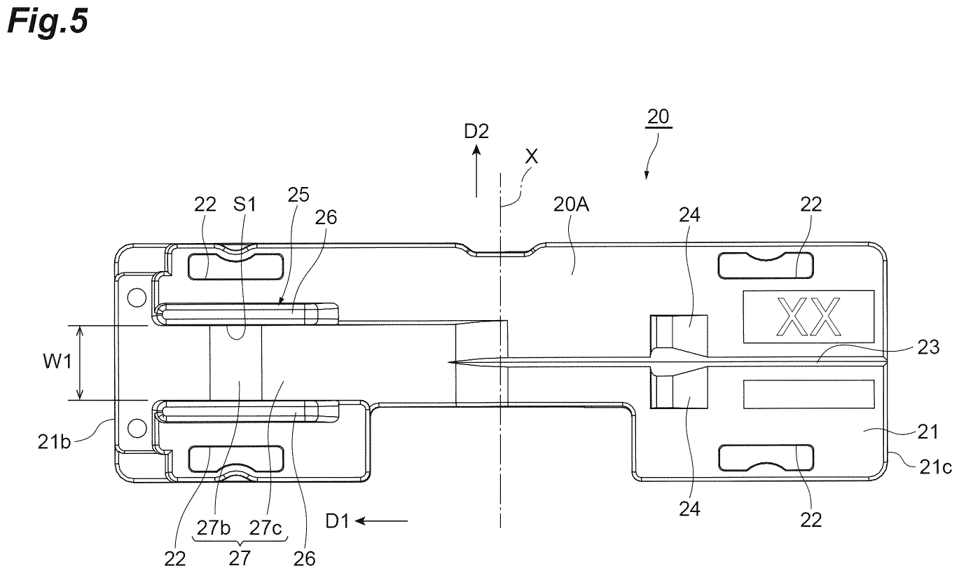

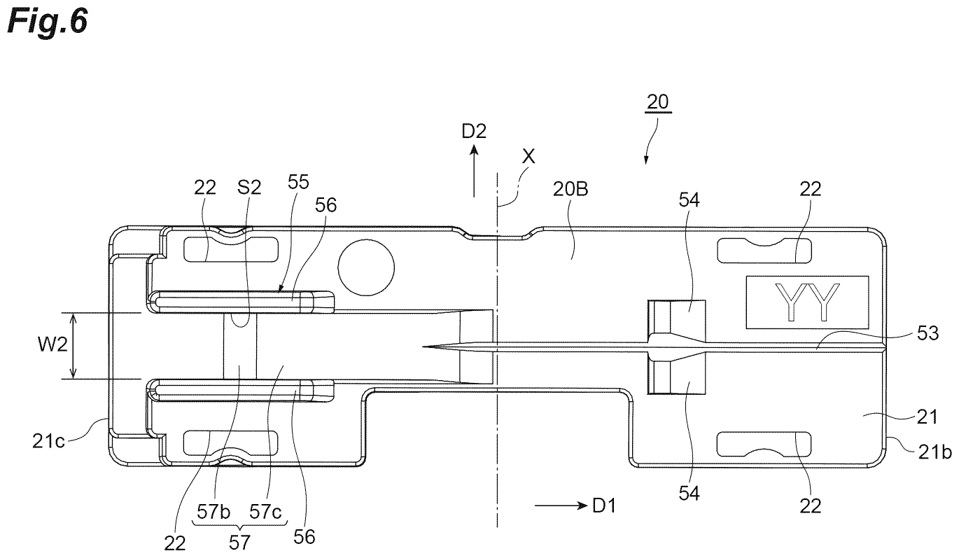

Next, the guide member 20 will be described in further detail. The guide member 20 is placeable on the base member 30 in a state where the orientation of the plate-shaped portion 21 in the thickness direction is changed. The guide member 20 has a first surface and a second surface facing a side opposite the first surface, and is placeable on the base member 30 with either the first surface or the second surface facing upward. FIG. 5 is a view showing a first surface 20A of the guide member 20, and FIG. 6 is a view showing a second surface 20B of the guide member 20.

As shown in FIGS. 5 and 6, the V-groove 23, the protruding portions 24, the first insertion portion 25, the first wall portions 26, and the first bottom surface 27 described above are formed on the first surface 20A. Similarly to the first surface 20A, a V-groove 53, protruding portions 54, second insertion portion 55, second wall portions 56, and a second bottom surface 57 are formed on the second surface 20B. For example, a mark (a portion marked “XX”) indicating the first surface 20A is formed between the V-groove 23 and the through-hole 22 on the first surface 20A. Similarly, a mark (a portion marked “YY”) indicating the second surface 20B is formed between the V-groove 53 and the through-hole 22 on the second surface 20B.

For example, the sizes of the V-groove 53 and the protruding portions 54 are the same as the sizes of the V-groove 23 and the protruding portions 24, respectively. However, the sizes of the V-groove 53 and the protruding portions 54 may be different from the sizes of the V-groove 23 and the protruding portions 24, respectively. For example, the V-groove 53 may be thinner than the V-groove 23, and a distance between the pair of protruding portions 54 may be narrower than a distance between the pair of protruding portions 24.

For example, a protruding height of each of the first wall portions 26 on the first surface 20A (a height of a portion protruding in the thickness direction of the guide member 20) is the same as a protruding height of each of the second wall portions 56 on the second surface 20B. The second bottom surface 57 has an inclined surface 57c similar to the inclined surface 27c, and an extending surface 57b similar to the extending surface 27b. A second insertion space S2 into which the optical fiber is inserted is formed in the second insertion portion 55. A width W2 of the second insertion space S2 (a length in a width direction of the guide member 20) is different from a width W1 of the first insertion space S1. In the present embodiment, the width W2 of the second insertion space S2 is narrower than the width W1 of the first insertion space S1.

As described above, the guide member 20 allows optical fibers to be inserted into both the first surface 20A and the second surface 20B. However, the type of an optical fiber placed on the first surface 20A and the type of an optical fiber placed on the second surface 20B are different from each other. As one example, any one of an optical fiber cable having a diameter of 0.25 mm, an optical fiber cable having a diameter of 0.9 mm, and an optical fiber cable (drop cable) having a diameter of 3.5 mm is inserted into the first surface 20A. Any one of an optical fiber cable having a diameter of 0.25 mm, an optical fiber cable having a diameter of 0.9 mm, or an optical fiber cable (drop cable) having a rectangular cross-section of 2 cm×3 cm is inserted into the second surface 20B.

In the case of the above example, an optical fiber cable having a diameter of 0.25 mm or an optical fiber cable having a diameter of 0.9 mm is inserted between the V-groove 23 and the pair of protruding portions 24 on the first surface 20A or between the V-groove 53 and the pair of protruding portions 54 on the second surface 20B. For example, the width W1 is 0.5 mm wider than the width W2. Therefore, an optical fiber cable having a diameter of 3.5 mm is inserted into the first insertion space S1 on the first surface 20A, and an optical fiber cable having a rectangular cross-section of 2 cm×3 cm is inserted into the second insertion space S2 on the second surface 20B. In such a manner, the guide member 20 according to the present embodiment has the first surface 20A on which the first insertion space S1 is formed, and the second surface 20B on which the second insertion space S2 is formed, so that a plurality of types (four types in the above example) of optical fiber cables can be inserted.

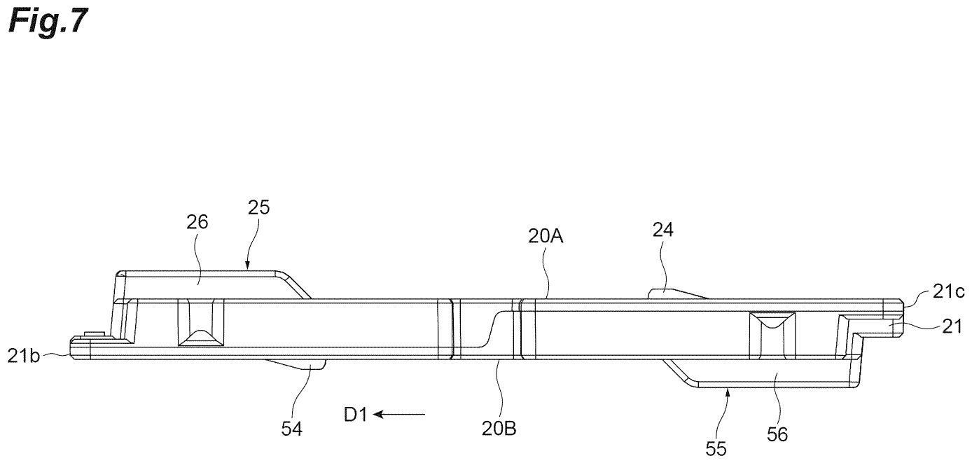

FIG. 7 is a side view of the guide member 20 when the guide member 20 is viewed along the width direction of the guide member 20. As shown in FIGS. 5, 6, and 7, the guide member 20 has a first end surface 21b facing a first direction D1 that is a direction in which the optical fiber extends, and a second end surface 21c facing a side opposite the first end surface 21b. The first insertion portion 25 is formed between the first end surface 21b and a reference line X passing through the center of the guide member 20 and extending along a second direction D2 that is the width direction of the guide member 20. The second insertion portion 55 is formed between the reference line X and the second end surface 21c.

Accordingly, the overall thickness of the guide member 20 can be suppressed. Since the first bottom surface 27 has the inclined surface 27c, the first bottom surface 27 is inclined such that the guide member 20 becomes thinner as the first bottom surface 27 extends toward the first end surface 21b. Since the second bottom surface 57 has the inclined surface 57c, the second bottom surface 57 is inclined such that the guide member 20 becomes thinner as the second bottom surface 57 extends toward the second end surface 21c. Therefore, the thickness of the guide member 20 can be further reduced.

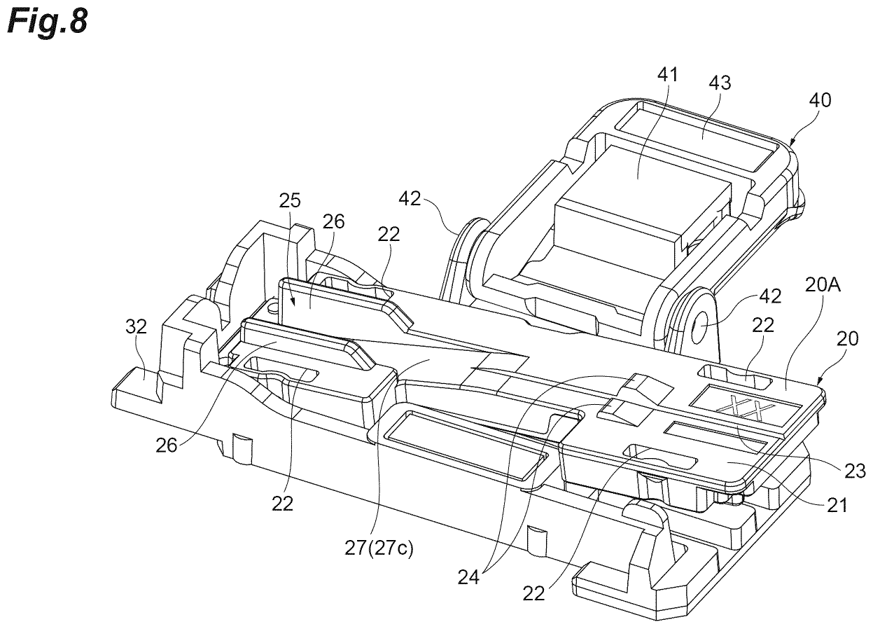

Next, an example of a method for assembling the optical fiber holder 5 and attaching the assembled optical fiber holder 5 to an attachment object (the optical fiber cutter 1) will be described. First, as shown in FIG. 8, the cover 40 is opened from the base member 30, and the guide member 20 is placed on the base member 30. At this time, depending on the type of an optical fiber that is inserted into the guide member 20, it is determined whether the first surface 20A or the second surface 20B faces upward, and the guide member 20 is placed on the base member 30 with the determined surface facing upward. FIG. 8 shows an example in which the first surface 20A faces upward.

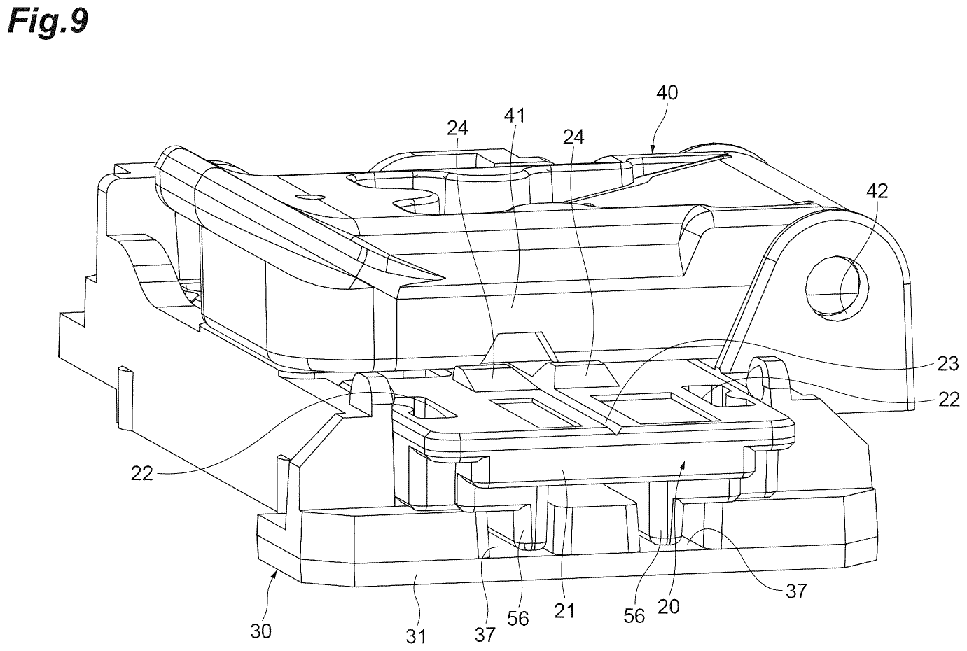

When the guide member 20 is placed on the base member 30, as shown in FIG. 9, a pair of the second wall portions 56 of the guide member 20 enter recesses 37 formed on an upper surface of the base member 30. For example, the base member 30 includes a pair of the recesses 37 aligned along the width direction of the base member 30, and the second wall portions 56 are inserted into the pair of respective recesses 37. Incidentally, when the second surface 20B faces upward, the first wall portions 26 are inserted into the pair of respective recesses 37.

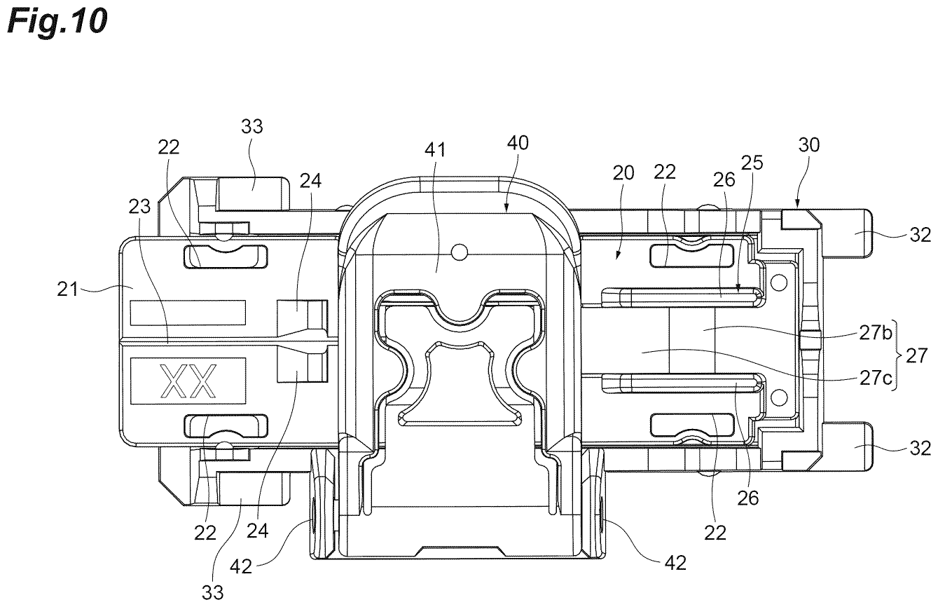

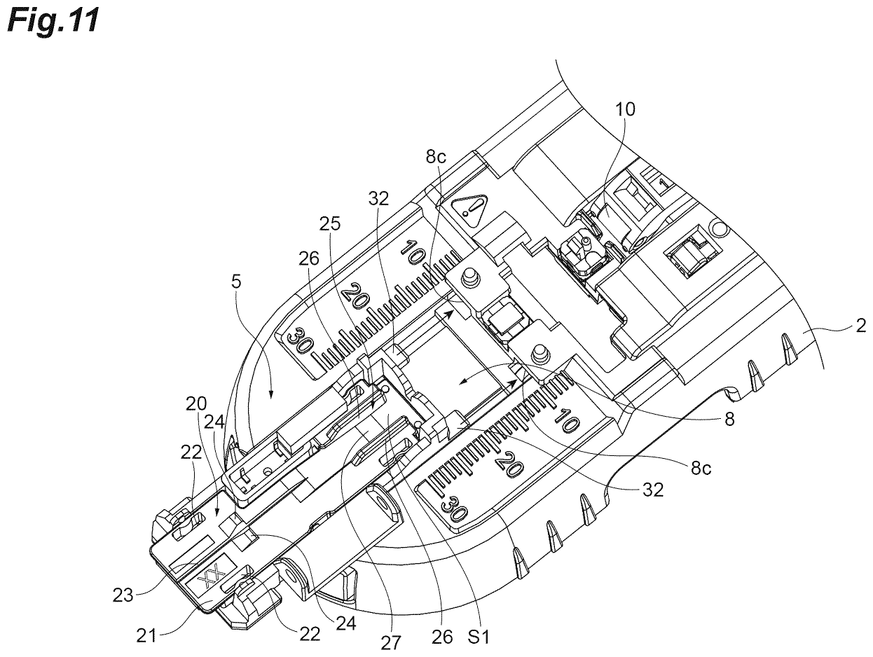

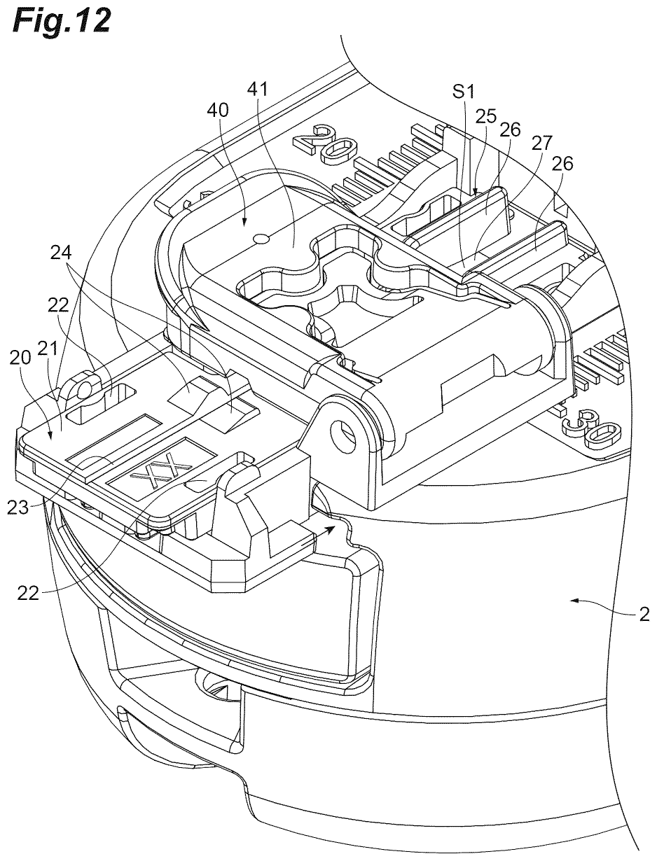

As shown in FIG. 10, for example, the cover body 41 is closed to cause the magnet 43 of the cover 40 to be attracted to the magnet 28 of the base member 30. As shown in FIGS. 11 and 12, the optical fiber holder 5 is attached to the attachment portion 8 of the optical fiber cutter 1. Specifically, the pawl portions 32 of the base member 30 are inserted into the respective holes 8c, and the protruding portions 33 of the base member 30 are inserted into the respective openings 8d.

In this case, the lifting of the optical fiber holder 5 from the optical fiber cutter 1 is suppressed by inserting the pawl portions 32 into the holes 8c. Then, the projection 35 of the base member 30 enters the depression 8b of the attachment portion 8. The projection 35 functions as a retainer that suppresses the coming off of the base member 30 from the attachment portion 8. As described above, in the optical fiber holder 5 according to the present embodiment, since the base member 30 includes at least one of the pawl portions 32 and the projection 35, the need for fixing means for fixing the optical fiber holder 5 to the attachment portion 8 can be eliminated. Namely, conventionally, the optical fiber holder is attached to the attachment portion by screwing. However, in the optical fiber holder 5 according to the present embodiment, since at least one of the pawl portions 32 and the projection 35 is provided, the need to screw the optical fiber holder 5 to the attachment portion 8 can be eliminated.

Incidentally, the disposition of the optical fiber in the optical fiber holder 5 may be performed after the optical fiber holder 5 is attached to the attachment portion 8 or may be performed before the optical fiber holder 5 is attached to the attachment portion 8. In such a manner, the timing for disposing the optical fiber in the optical fiber holder 5 can be changed as appropriate.

Next, actions and effects obtained from the optical fiber holder 5 according to the present embodiment will be described. The optical fiber holder 5 includes the guide member 20 placed on the base member 30, and the guide member 20 has the first surface 20A and the second surface 20B facing the side opposite the first surface 20A. The first surface 20A includes the first insertion portion 25 in which the first insertion space S1 into which an optical fiber is inserted is formed, and the second surface 20B includes the second insertion portion 55 in which the second insertion space S2 into which an optical fiber is inserted is formed. The width W1 of the first insertion space S1 is different from the width W2 of the second insertion space S2. Therefore, the type of the optical fiber inserted into the first insertion space S1 and the type of the optical fiber inserted into the second insertion space S2 can be made different from each other. Therefore, a plurality of types of optical fibers can be inserted.

The guide member 20 is placeable on the base member 30 with either the first surface 20A or the second surface 20B facing upward. Therefore, by placing the guide member 20 on the base member 30 in a state where either the first surface 20A or the second surface 20B faces upward, a single guide member 20 is allowed to hold a plurality of types of optical fibers. Therefore, an increase in the number of components can be suppressed while holding a plurality of types of optical fibers.

As described above, the guide member 20 may have the first end surface 21b facing the first direction D1 that is the direction in which the optical fiber extends, and the second end surface 21c facing the side opposite the first end surface 21b. The first insertion portion 25 may be formed between the first end surface 21b and the reference line X passing through the center of the guide member 20 and extending along the second direction D2 that is the width direction of the guide member 20. The second insertion portion 55 may be formed between the reference line X and the second end surface 21c. In this case, the position of the first insertion portion 25 in the first direction D1 and the position of the second insertion portion 55 in the first direction D1 can be made different from each other. Therefore, an excessive increase in the thickness of the guide member 20 can be suppressed.

As described above, the first insertion portion 25 may include the pair of first wall portions 26 and the first bottom surface 27 that define the first insertion space S1, and the second insertion portion 55 may include the pair of second wall portions 56 and the second bottom surface 57 that define the second insertion space S2. The first bottom surface 27 may be inclined such that the guide member 20 becomes thinner as the first bottom surface 27 extends toward the first end surface 21b. The second bottom surface 57 may be inclined such that the guide member 20 becomes thinner as the second bottom surface 57 extends toward the second end surface 21c. In this case, the alignment of the optical fiber can be easily performed.

As described above, the base member 30 may include recesses 37 that either the pair of first wall portions 26 or the pair of second wall portions 56 enters. In this case, when the guide member 20 is placed on the base member 30, either the pair of first wall portions 26 or the pair of second wall portions 56 enter the recesses 37 of the base member 30. Therefore, the thickness of the optical fiber holder 5 can be reduced.

As described above, the optical fiber holder 5 may be attached to the optical fiber cutter 1 that is an attachment object. The base member 30 may include the projection 35 that enters the depression 8b formed in the optical fiber cutter 1. The position of the projection 35 with respect to the base member 30 may be changeable by elastic deformation. In this case, the base member 30 includes the projection 35 that enters the depression 8b of the optical fiber cutter 1, and the projection 35 has elasticity. Therefore, the optical fiber holder 5 can be easily attached to the optical fiber cutter 1 by bending the projection 35.

As described above, the optical fiber holder 5 may be attached to the optical fiber cutter 1, and the base member 30 may include the pawl portions 32 that are inserted into the holes 8c formed in the optical fiber cutter 1. The lifting of the optical fiber holder 5 from the optical fiber cutter 1 may be suppressed in a state where the pawl portions 32 are inserted into the holes 8c. In this case, the base member 30 includes the pawl portions 32 that are inserted into the holes 8c of the optical fiber cutter 1, and the lifting of the base member 30 can be suppressed by inserting the pawl portions 32 into the holes 8c.

The embodiment of the optical fiber holder according to the present disclosure has been described above. However, the present invention is not limited to the above-described embodiment. Namely, those skilled in the art easily recognize that various modifications and changes can be made to the present invention within the scope of the concept described in the claims. For example, the shape, the size, the material, the number, and the disposition mode of each part of the optical fiber holder can be appropriately changed without departing from the above-described concept.

For example, in the above-described embodiment, the optical fiber holder 5 that is attached to the optical fiber cutter 1 has been described. Namely, an example in which the attachment object to which the optical fiber holder 5 is attached is the optical fiber cutter 1 has been described. However, the object to which the optical fiber holder is attached may be an object other than the optical fiber cutter. For example, the optical fiber holder may be attached to a fusion splicer that fusion-splices a pair of optical fibers. In this case, the fusion splicer is the attachment object.

### REFERENCE SIGNS LIST

1 optical fiber cutter
2 base body
3 cover
5 optical fiber holder
6 blade
7 movable member
8 attachment portion
8b depression
8c hole
8d opening
10 fiber holding portion
20 guide member
20A first surface
20B second surface
21 plate-shaped portion
21b first end surface
21c second end surface
22 through-hole
23 V-groove
24 protruding portion
25 first insertion portion
26 first wall portion
27 first bottom surface
27b extending surface
27c inclined surface
28 magnet
30 base member
31 base portion
32 pawl portion
33 protruding portion
35 projection
36 slit
37 recess
40 cover
42 shaft portion
43 magnet
53 V-groove
54 protruding portion
55 second insertion portion
56 second wall portion
57 second bottom surface
57b extending surface
57c inclined surface
D1 first direction
D2 second direction
D3 third direction
S1 first insertion space
S2 second insertion space
W1,W2 width
X reference line

What is claimed is:

1. An optical fiber holder, comprising:
a base member; and
a guide member placed on the base member,
wherein the guide member has a first surface and a second surface facing a side opposite the first surface,
the guide member is placeable on the base member with either the first surface or the second surface facing upward,
the first surface includes a first insertion portion in which a first insertion space into which an optical fiber is inserted is formed,
the second surface includes a second insertion portion in which a second insertion space into which an optical fiber is inserted is formed, and
a width of the first insertion space is different from a width of the second insertion space.

2. The optical fiber holder according to claim 1,
wherein the guide member has a first end surface facing a first direction in which the optical fiber extends, and a second end surface facing a side opposite the first end surface,
the first insertion portion is formed between the first end surface and a reference line passing through a center of the guide member and extending along a second direction that is a width direction of the guide member, and
the second insertion portion is formed between the reference line and the second end surface.

3. The optical fiber holder according to claim 2,
wherein the first insertion portion includes a pair of first wall portions and a first bottom surface that define the first insertion space,
the second insertion portion includes a pair of second wall portions and a second bottom surface that define the second insertion space,
the first bottom surface is inclined such that the guide member becomes thinner as the first bottom surface extends toward the first end surface, and
the second bottom surface is inclined such that the guide member becomes thinner as the second bottom surface extends toward the second end surface.

4. The optical fiber holder according to claim 3,
wherein the base member includes recesses that either the pair of first wall portions or the pair of second wall portions enters.

5. The optical fiber holder according to claim 1,
wherein the guide member includes a V-groove into which the optical fiber is inserted, and a pair of protruding portions located on both sides of the V-groove.

6. The optical fiber holder according to claim 3,
wherein the guide member includes a V-groove into which the optical fiber is inserted, and the first bottom surface is formed on an extension line of the V-groove extending linearly.

7. The optical fiber holder according to claim 6,
wherein the first bottom surface has an inclined surface extending obliquely downward from an end portion of the V-groove, and an extending surface extending from an end portion of the inclined surface opposite the V-groove.

8. The optical fiber holder according to claim 1, further comprising:
an attachment portion to which the base member is attached,
wherein the attachment portion includes a pair of openings,
the base member includes a base portion on which the guide member is placed, and protruding portions protruding from the base portion in a width direction of the base member, and
the protruding portions are inserted into the openings.

9. The optical fiber holder according to claim 1,
wherein the guide member includes a plate-shaped portion attached to the base member, and is placeable on the base member in a state where an orientation of the plate-shaped portion in a thickness direction is changed.

10. The optical fiber holder according to claim 1,
wherein a mark indicating the first surface is formed on the first surface, and a mark indicating the second surface is formed on the second surface.

11. The optical fiber holder according to claim 1,
wherein a type of the optical fiber placed on the first surface and a type of the optical fiber placed on the second surface are different from each other.

12. The optical fiber holder according to claim 1,
wherein the optical fiber holder is attached to an attachment object,
the base member includes a projection that enters a depression formed in the attachment object, and
a position of the projection with respect to the base member is changeable by elastic deformation.

13. The optical fiber holder according to claim 12,
wherein the base member includes a base portion on which the guide member is placed, and a slit penetrating through the base portion and formed in a U-shape in a bottom view, and
the projection is formed inside the slit in a bottom view.

14. The optical fiber holder according to claim 1,
wherein the optical fiber holder is attached to an attachment object,
the base member includes a pawl portion that is inserted into a hole formed in the attachment object, and
a lifting of the base member from the attachment object is suppressed in a state where the pawl portion is inserted into the hole.
